(19) United States
(12) Patent Application Publication
(10) Pub. No.: US 2010/0303256 A1
(43) Pub. Date: Dec. 2, 2010

(54) NOISE CANCELLATION SYSTEM WITH SIGNAL-TO-NOISE RATIO DEPENDENT GAIN

(76) Inventor: Richard Clemow, Gerrards Cross (GB)

Correspondence Address: DICKSTEIN SHAPIRO LLP, 1825 EYE STREET NW, Washington, DC, 20006-5403, US

(21) Appl. No.: 12/808,578

(22) PCT Filed: Dec. 15, 2008
(86) PCT No.: PCT/GB2008/051187

§ 371 Date: Jul. 15, 2010

(30) Foreign Application Priority Data
Dec. 21, 2007 (GB) 0725113.5
Jun. 16, 2008 (GB) 0811000.9

(51) Int. Cl. H04B 15/00

(52) U.S. Cl. 381/94.1

(57) ABSTRACT

There is provided a noise cancellation system, comprising: a voice input, for receiving a wanted signal; a noise input for receiving a detected signal representative of ambient noise; a signal processor, for generating a noise cancellation signal for addition to the wanted signal, the signal processor having an adjustable gain; and control circuitry, for determining a relationship between levels of the wanted signal and the detected signal, and for controlling the adjustable gain on the basis of the determined relationship.

The present invention relates to noise cancellation systems, and in particular to a method for adapting the gain of such systems.

### BACKGROUND

Noise cancellation systems are known, in which an electronic noise signal representing ambient noise is applied to a signal processing circuit, and the resulting processed noise signal is then applied to a speaker, in order to generate a sound signal. In order to achieve noise cancellation, the generated sound should approximate as closely as possible the inverse of the ambient noise, in terms of its amplitude and its phase.

In particular, feedforward noise cancellation systems are known, for use with headphones or earphones, in which one or more microphones mounted on the headphones or earphones detect an ambient noise signal in the region of the wearer's ear. In order to achieve noise cancellation, the generated sound then needs to approximate as closely as possible the inverse of the ambient noise, after that ambient noise has itself been modified by the headphones or earphones. One example of modification by the headphones or earphones is caused by the different acoustic path the noise must take to reach the wearer's ear, travelling around the edge of the headphones or earphones.

The microphone used to detect the ambient noise signal and the loudspeaker used to generate the sound signal from the processed noise signal will in practice also modify the signals. This modification generally has a frequency-dependent component (i.e. being more sensitive at some frequencies than at others) and a gain component (i.e. a non-frequency-dependent component). One example of this is when the speaker is closely coupled to the ear of a user, causing the frequency response of the loudspeaker to change due to cavity effects.

Therefore the signal processor used in the noise cancellation system to generate the noise cancellation signal must take into account the modification of the ambient noise by the headphones or earphones, as well as the modification of the noise signal by the microphone and loudspeaker.

### SUMMARY OF INVENTION

According to a first aspect of the present invention, there is provided a noise cancellation system, comprising:
a voice input, for receiving a wanted signal;
a noise input for receiving a detected signal representative of ambient noise;
a signal processor, for generating a noise cancellation signal for addition to the wanted signal, the signal processor having an adjustable gain; and
control circuitry, for determining a relationship between levels of the wanted signal and the detected signal, and for controlling the adjustable gain on the basis of the determined relationship.

According to a second aspect of the present invention, there is provided a method of controlling a noise cancellation system, comprising: receiving a wanted signal; receiving a detected signal representative of ambient noise; generating a noise cancellation signal for addition to the wanted signal, said generating comprising at least the substep of applying gain; determining a relationship between levels of the wanted signal and the detected signal; and adjusting said gain on the basis of the determined relationship.

### BRIEF DESCRIPTION OF THE DRAWINGS

For a better understanding of the present invention, and to show more clearly how it may be carried into effect, reference will now be made, by way of example, to the following drawings, in which:

FIG. 1 illustrates a noise cancellation system in accordance with an aspect of the invention;

FIG. 2 illustrates a signal processing circuit in accordance with an aspect of the invention in the noise cancellation system of FIG. 1; and

FIG. 3 is a schematic graph showing variation of gain with signal-to-noise ratio according to an embodiment of the present invention.

### DETAILED DESCRIPTION

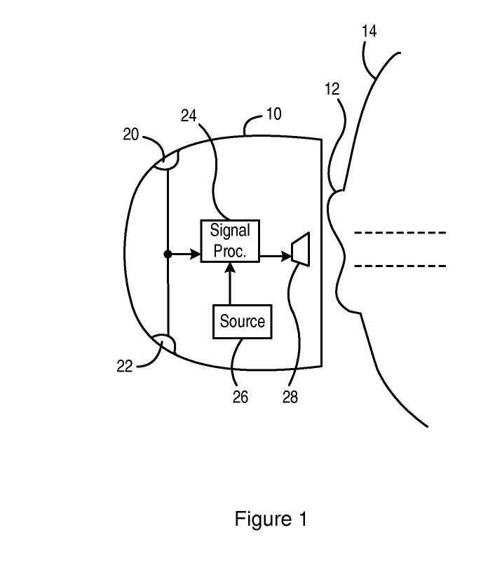

FIG. 1 illustrates in general terms the form and use of a noise cancellation system in accordance with the present invention.

Specifically, FIG. 1 shows an earphone 10, being worn on the outer ear 12 of a user 14. Thus, FIG. 1 shows a supra-aural earphone that is worn on the ear, although it will be appreciated that exactly the same principle applies to circumaural headphones worn around the ear and to earphones worn in the ear such as so-called ear-bud phones. The invention is equally applicable to other devices intended to be worn or held close to the user's ear, such as mobile phones and other communication devices.

Ambient noise is detected by microphones 20, 22, of which two are shown in FIG. 1, although any number more or less than two may be provided. Ambient noise signals generated by the microphones 20, 22 are combined, and applied to signal processing circuitry 24, which will be described in more detail below. In one embodiment, where the microphones 20, 22 are analogue microphones, the ambient noise signals may be combined by adding them together. Where the microphones 20, 22 are digital microphones, i.e. where they generate a digital signal representative of the ambient noise, the ambient noise signals may be combined alternatively, as will be familiar to those skilled in the art. Further, the microphones could have different gains applied to them before they are combined, for example in order to compensate for sensitivity differences due to manufacturing tolerances.

This illustrated embodiment of the invention also contains a source 26 of a wanted signal. For example, where the noise cancellation system is in use in an earphone, such as the earphone 10 that is intended to be able to reproduce music, the source 26 may be an inlet connection for a wanted signal from an external source such as a sound reproducing device. In other applications, for example where the noise cancellation system is in use in a mobile phone or other communication device, the source 26 may include wireless receiver circuitry for receiving and decoding radio frequency signals.

The wanted signal from the source 26 is applied through the signal processing circuitry 24 to a loudspeaker 28, which generates a sound signal in the vicinity of the user's ear 12. In addition, the signal processing circuitry 24 generates a noise cancellation signal that is also applied to the loudspeaker 28.

One aim of the signal processing circuitry 24 is to generate a noise cancellation signal, which, when applied to the loudspeaker 28, causes it to generate a sound signal in the ear 12 of the user that is the inverse of the ambient noise signal reaching the ear 12.

In order to achieve this, the signal processing circuitry 24 needs to generate from the ambient noise signals generated by the microphones 20, 22 a noise cancellation signal that takes into account the properties of the microphones 20, 22 and of the loudspeaker 28, and also takes into account the modification of the ambient noise that occurs due to the presence of the earphone 10.

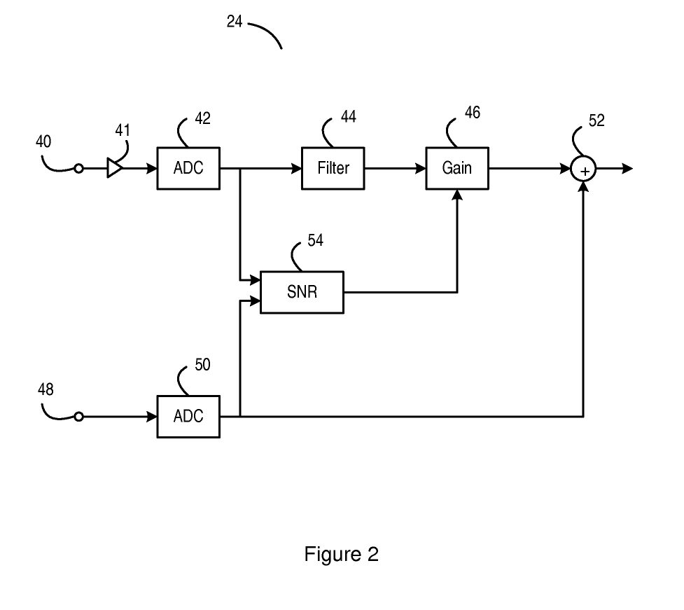

FIG. 2 shows in more detail the form of the signal processing circuitry 24. An input 40 is connected to receive a noise signal, for example directly from the microphones 20, 22, representative of the ambient noise. The noise signal is input to an analogue-to-digital converter (ADC) 42, and is converted to a digital noise signal. The digital noise signal is input to a filter 44, which outputs a filtered signal. The filter 44 may be any filter for generating a noise cancellation signal from a detected ambient noise signal, i.e. the filter 44 substantially generates the inverse signal of the detected ambient noise. For example, the filter 44 may be adaptive or non-adaptive, as will be apparent to those skilled in the art.

The filtered signal is output to a variable gain block 46. The control of the variable gain block 46 will be explained later. However, in general terms the variable gain block 46 applies gain to the filtered signal in order to generate a noise cancellation signal that more accurately cancels the detected ambient noise.

The signal processor 24 further comprises an input 48 for receiving a voice or other wanted signal, as described above. The voice signal is input to an ADC 50, where it is converted to a digital voice signal. Alternatively, the voice signal may be received in digital form, and applied directly to the signal processor 24. The digital voice signal is then added to the noise cancellation signal output from the variable gain block 46 in an adding element 52. The combined signal is then output from the signal processor 24 to the loudspeaker 28.

According to the present invention, both the digital noise signal and the digital voice signal are input to a signal-to-noise ratio (SNR) block 54. The SNR block 54 determines a relationship between the level of the voice signal and the level of the noise signal, and outputs a control signal to the variable gain block 46 in accordance with the determined relationship. In one embodiment, the SNR block 54 detects a ratio of the voice signal to the noise signal, and outputs a control signal to the variable gain block 46 in accordance with the detected ratio.

The term “level” (of a signal, etc) is used herein to describe the magnitude of a signal. The magnitude may be the amplitude of the signal, or the amplitude of the envelope of the signal. Further, the magnitude may be determined instantaneously, or averaged over a period of time.

The inventors have realized that in an environment where the ambient noise is high, such as a crowded area, or a concert, etc, a user of the noise cancellation system 10 will be tempted to push the system closer to his ears. For example, if the noise cancellation system is embodied in a phone, the user may press the phone closer to his ear in order to better hear the caller's voice.

However, this has the effect of pushing the loudspeaker 28 closer to the ear, increasing the coupling between the loudspeaker 28 in the ear, i.e. a constant level output from the loudspeaker 28 will appear louder to the user. Further, the coupling between the ambient environment and the ear will most likely be reduced. In the case of a phone, for example, this could be because the phone forms a tighter seal around the ear, blocking more effectively the ambient noise.

Both of these effects have the effect of reducing the effectiveness of the noise cancellation, by increasing the volume of the noise cancellation signal relative to the volume of the ambient noise, when the aim is that these should be equal and opposite. That is, the ambient noise heard by the user will be quieter, while the noise cancellation signal will be louder. Therefore, counter-intuitively, pushing the system 10 closer to the ear actually reduces the user's ability to hear the voice signal, because the noise cancellation is less effective.

According to the present invention, when the user has pushed the system 10 closer to his ear, the gain applied to the noise cancellation signal is reduced to counter the effects described above. A relationship between the noise signal and the voice signal is used to determine when the user is in an environment that he is likely to push the system 10 closer to his ear, and then to reduce the gain.

For example, in a noisy environment the SNR will be low, and therefore the SNR may be used to determine the level of gain to be applied in the gain block 46. In one embodiment, the gain may vary continuously with the detected SNR. In an alternative embodiment, the SNR may be compared with a threshold value and the gain reduced in steps when the SNR falls below the threshold value. In a yet further alternative embodiment, the gain may vary smoothly with the SNR only when the SNR falls below the threshold value.

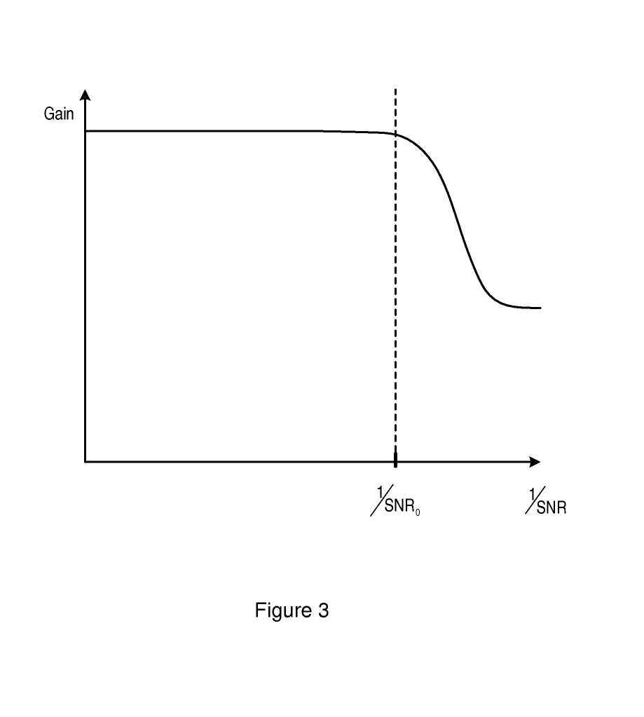

FIG. 3 shows a schematic graph of the gain versus the inverse of the SNR for one embodiment. As can be seen, the gain is reduced smoothly when the SNR falls below a threshold value SNR₀. In the illustrated embodiment, the gain is not reduced to zero when the SNR falls below the threshold, as in practice a user will be unable to move the speaker so close to his ear that ambient noise is cut out altogether. Rather, the gain tends to some finite value as the SNR tends to zero.

Comparison with a threshold value is advantageous because the user may not push the system 10 closer to his ear except in situations where ambient noise is a particular problem. Therefore, the threshold value may be set so that gain is only reduced at low SNR values.

According to a further embodiment, the signal processor 24 may comprise a ramp control block (not shown). The ramp control block controls the gain applied in the variable gain block 46 such that the gain does not vary rapidly. For example, when the system 10 is embodied in a mobile phone, the distance between the loudspeaker 28 and the ear may vary considerably and rapidly. In this instance it is preferable that the gain applied to the noise cancellation signal does not also vary rapidly as this may cause rapid fluctuations, irritating the user.

Various modifications may be made to the embodiments described above without departing from the scope of the claims appended hereto. For example, a digital voice signal and/or a digital noise signal may be input directly to the signal processor 28, and in this case the signal processor 28 would not comprise ADCs 42, 50. Further, the SNR block 54 may receive analogue versions of the noise signal and the voice signal, rather than digital signals.

It will be clear to those skilled in the art that the implementation may take one of several hardware or software forms, and the intention of the invention is to cover all these different forms.

Noise cancellation systems according to the present invention may be employed in many devices, as would be appreciated by those skilled in the art. For example, they may be employed in mobile phones, headphones, earphones, headsets, etc.

The skilled person will recognise that the above-described apparatus and methods may be embodied as processor control code, for example on a carrier medium such as a disk, CD- or DVD-ROM, programmed memory such as read only memory (firmware), or on a data carrier such as an optical or electrical signal carrier. For many applications, embodiments of the invention will be implemented on a DSP (digital signal processor), ASIC (application specific integrated circuit) or FPGA (field programmable gate array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (very high speed integrated circuit hardware description language). As the skilled person will appreciate, the code may be distributed between a plurality of coupled components in communication with one another. Where appropriate, the embodiments may also be implemented using code running on a field-(re-)programmable analogue array or similar device in order to configure analogue/digital hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A noise cancellation system, comprising:
a voice input, for receiving a wanted signal;
a noise input for receiving a detected signal representative of ambient noise;
a signal processor, for generating a noise cancellation signal for addition to the wanted signal, the signal processor having an adjustable gain; and
control circuitry, for determining a relationship between levels of the wanted signal and the detected signal, and for controlling a level of the adjustable gain on the basis of the determined relationship.

2. A noise cancellation system as claimed in claim 1, wherein the control circuitry is adapted to determine a ratio of the levels of the wanted signal and the detected signal, and wherein the control circuitry is adapted to control the level of the adjustable gain on the basis of the determined ratio.

3. A noise cancellation system as claimed in claim 2, wherein the control circuitry is adapted to reduce the level of the adjustable gain when the ratio is below a threshold value.

4. A noise cancellation system as claimed in claim 3, wherein the level of the adjustable gain is reduced smoothly when the ratio is below the threshold value.

5. A noise cancellation system as claimed in claim 3, wherein the level of the adjustable gain is reduced in steps when the ratio is below the threshold value.

6. A noise cancellation system as claimed in claim 1, further comprising:
a ramp control, for reducing the rate of change of the level of the adjustable gain.

7. A noise cancellation system as claimed in claim 1, wherein the level of the wanted signal and the level of the detected signal are the amplitude of the wanted signal and the amplitude of the detected signal, respectively.

8. A noise cancellation system as claimed in claim 1, wherein the level of the wanted signal and the level of the detected signal are the amplitude of the envelope of the wanted signal and the amplitude of the envelope of the detected signal, respectively.

9. A noise cancellation system as claimed in claim 1, wherein the level of the wanted signal and the level of the detected signal are determined instantaneously.

10. A noise cancellation system as claimed in claim 1, wherein the level of the wanted signal and the level of the detected signal are averaged over a period of time.

11. An integrated circuit, comprising:
a noise cancellation system as claimed in claim 1.

12. A mobile phone, comprising:
an integrated circuit as claimed in claim 11.

13. A pair of headphones, comprising:
an integrated circuit as claimed in claim 11.

14. A pair of earphones, comprising:
an integrated circuit as claimed in claim 11.

15. A headset, comprising:
an integrated circuit as claimed in claim 11.

16. A method of controlling a noise cancellation system, comprising:
receiving a wanted signal;
receiving a detected signal representative of ambient noise;
generating a noise cancellation signal for addition to the wanted signal, said generating comprising at least the substep of applying gain;
determining a relationship between levels of the wanted signal and the detected signal; and
adjusting a level of said gain on the basis of the determined relationship.

17. A method as claimed in claim 16, further comprising:
determining a ratio of the levels of the wanted signal and the detected signal, and adjusting the level of the gain on the basis of the determined ratio.

18. A method as claimed in claim 17, further comprising:
reducing the level of the gain when the ratio is below a threshold value.

19. A method as claimed in claim 18, further comprising:
reducing the level of the gain smoothly when the ratio is below the threshold value.

20. A method as claimed in claim 18, further comprising:
reducing the level of the gain in steps when the ratio is below the threshold value

21. A method as claimed in claim 16, wherein the level of the wanted signal and the level of the detected signal are the amplitude of the wanted signal and the amplitude of the detected signal, respectively.

22. A method as claimed in claim 16, wherein the level of the wanted signal and the level of the detected signal are the amplitude of the envelope of the wanted signal and the amplitude of the envelope of the detected signal, respectively.

23. A method as claimed in claim 16, wherein the level of the wanted signal and the level of the detected signal are determined instantaneously.

24. A method as claimed in claim 16, wherein the level of the wanted signal and the level of the detected signal are averaged over a period of time.
